(19) United States
(12) Patent Application Publication
(10) Pub. No.: US 2007/0047504 A1
(43) Pub. Date: Mar. 1, 2007

(54) Data re-routing method for dual mode terminal after handover

(76) Inventors: Ammad Akram, Reading (GB); Nikolaos Prelorentzos, Abingdon (GB); Makis Kasapidis, Yokohama (JP)

Correspondence Address: RATNERPRESTIA, P.O. BOX 980, VALLEY FORGE, PA, 19482, US

(21) Appl. No.: 10/561,664

(22) PCT Filed: Jun. 15, 2004
(86) PCT No.: PCT/GB04/02482

§ 371 Date: Jul. 20, 2006

(30) Foreign Application Priority Data
Jun. 16, 2003 (GB) 0313969.8

(51) Int. Cl. H04Q 7/24

(52) U.S. Cl. 370/338; 370/352

(57) ABSTRACT

A dual mode (e.g. WLAN/UMTS) terminal with two network interfaces sends one interface to sleep mode following handover from one network to the other. Here sleep mode is synchronised with the end of the data stream, either by marking the stream or in response to sending a handover related SIP ACK message to the corresponding node.

This invention relates to mobile communications and in particular it relates to a method for saving power in a mobile node after the mobile node has undergone handover from one network to another.

### INTRODUCTION

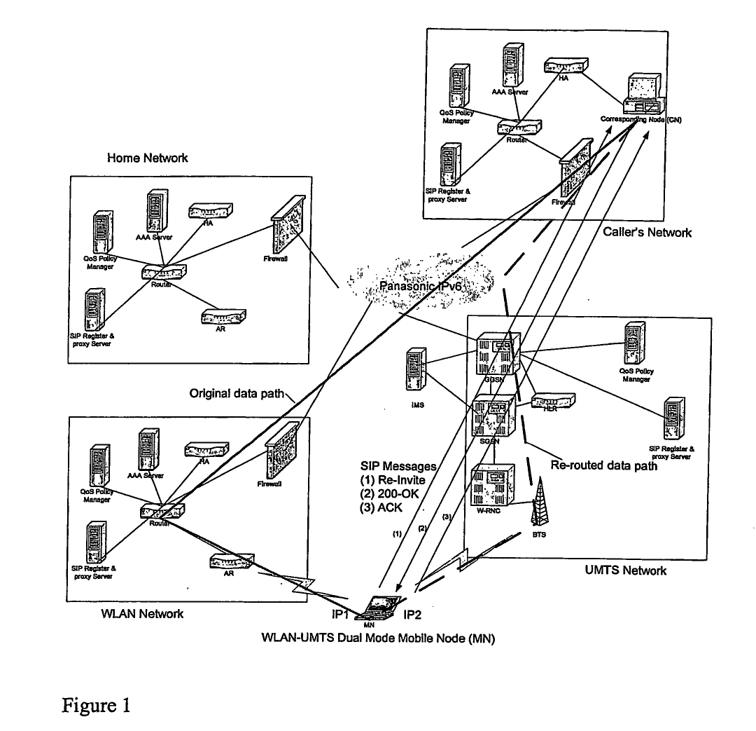

With reference to FIG. 1, a dual mode WLAN (Wireless Local Area Network)—UMTS (Universal Mobile Telecommunications System) mobile node (MN) wireless terminal has IP (Internet Protocol) connectivity with both WLAN and UMTS networks. IP connectivity to a network implies that a particular physical interface on the terminal is associated with an IP address derived from the prefix being used by the network. An IP address can be acquired through auto-configuration or with the assistance of a network element such as a DHCP (Dynamic Host Configuration Protocol). In the figure, IP1 and IP2 indicate the IP addresses used to reach the MN via the WLAN and UMTS networks respectively.

Using the SIP (Session Initiation Protocol, International Engineering Task Force RFC 3261) signalling protocol, a media path indicated by the solid line has been established between a corresponding node (CN) in the caller's network and the MN wireless terminal via the Internet and WLAN networks. The media path can, for example, be used to transport data packets related to Internet telephone calls (VoIP), multimedia distribution and multimedia conferences. Initially, the final leg of this media path is through the WLAN network.

Owing to reasons of mobility or some other reason, the quality of the established media path from CN to MN through the WLAN could begin to deteriorate as the MN moves away from the WLAN network. One possible metric used by the MN to detect decreasing channel quality could be L2 signal strength. Under these circumstances, it could be advantageous for the MN to attempt handover from the WLAN to an alternative available network in order to maintain the media path between CN and MN. The alternative network shown in FIG. 1 is the UMTS network. It is also possible the MN itself could initiate the handover in response to knowledge or events such as the alternative network offering a lower call charge during a certain period in the day etc.

To facilitate seamless data transfer between CN and MN, the MN with the assistance of the CN must establish a new media path through the alternative UMTS network as part of the handover process. The CN does not send any further data packets to the MN through the old WLAN media path once the new media path through the UMTS network has been successfully established, all further data packets are instead routed to the MN through the UMTS media path.

On the basis of a SIP mobility related procedure (described below), the CN is triggered to re-route data packets for the MN through the new UMTS network rather than the old WLAN network. However, this switch does not impact on data packets that are already in transit to the MN through the old WLAN media path. Therefore, for some intervening period, data packets will arrive at the MN through both available media paths until all the WLAN packets transmitted before the switch have been delivered. It is expected that after some pre-determined period of inactivity on its WLAN interface, the MN will send this interface into sleep mode to conserve power. It is an object of the present invention to improve this power conservation.

In one aspect, the invention provides a method of operating a MN as claimed in annexed claim 1. Thus in accordance with the invention, the cessation of data packets received through the first network or old WLAN network is synchronised with putting the MN WLAN interface to sleep mode to optimise MN power consumption.

The trigger may be a signal sent to the mobile node from an external source, such as a signal from the second network advertising an advantageous call rate or the first network advising of imminent congestion. Alternatively, as noted above, the trigger could be a signal generated by the mobile node itself, either in response to stored information or in response to measurements related to, for example, channel quality or mobility.

Usually the handover would involve a request from the mobile node to the corresponding node via the second network, a response from the corresponding node and an acknowledgement from the mobile node. The initiation of sleep mode may be synchronised with the sending of the acknowledgement message, for example to take place at a predetermined time following the sending of the acknowledgement message. Similarly, the initiation of sleep mode may also be synchronised with the arrival of the 200-OK response message from the corresponding node, for example to take place at a predetermined time following the arrival of the 200-OK response message. Both methods are more efficient than simply initiating sleep mode after a period of network “silence”.

In the preferred embodiment of the invention, however, sleep mode is initiated in response to a marker in the data stream received over the first network.

Thus another aspect of the invention provides a method of routing data packets as claimed in claim 7. In this method, the corresponding node preferably marks the last or last few data packets sent via the first network. Furthermore the marker is preferably in the packet header so as not to impose any additional overhead.

The invention also provides a computer program product enabling an existing mobile node to be modified to operate according to the invention.

Related work includes EP 1085 779, Alcatel that refers to using packet marking at the transmitter to synchronise packet reception from two paths. For example, the last marked packet on the first path is used to unblock the transmission on the second path. This prior art seeks to simplify the receiver structure (at the expense of transmitter complexity) by removing the need to have 2 receiver/demodulator etc chains.

U.S. Pat. No. 5,896,373, Nokia describes a method of embedding information within specialised marker ATM cells indicating the extent of time before the stream of conventional ATM cells comes to an end on a particular path. In the preferred embodiment, the present invention embeds the marker within the actual packet stream of interest and contains no actual information other than its use as a flag to indicate that the packet stream has come to an end.

An embodiment of the invention will now be described by way of example only and with reference to the accompanying drawings in which:

FIG. 1 schematically illustrates the general method of data re-routing between CN and MN from initial WLAN to new alternative UMTS networks.

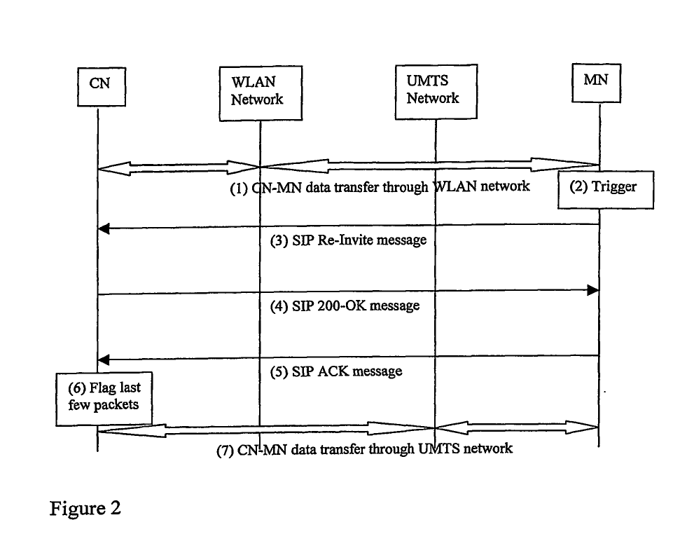

FIG. 2 represents a signal flow diagram of the data re-routing method.

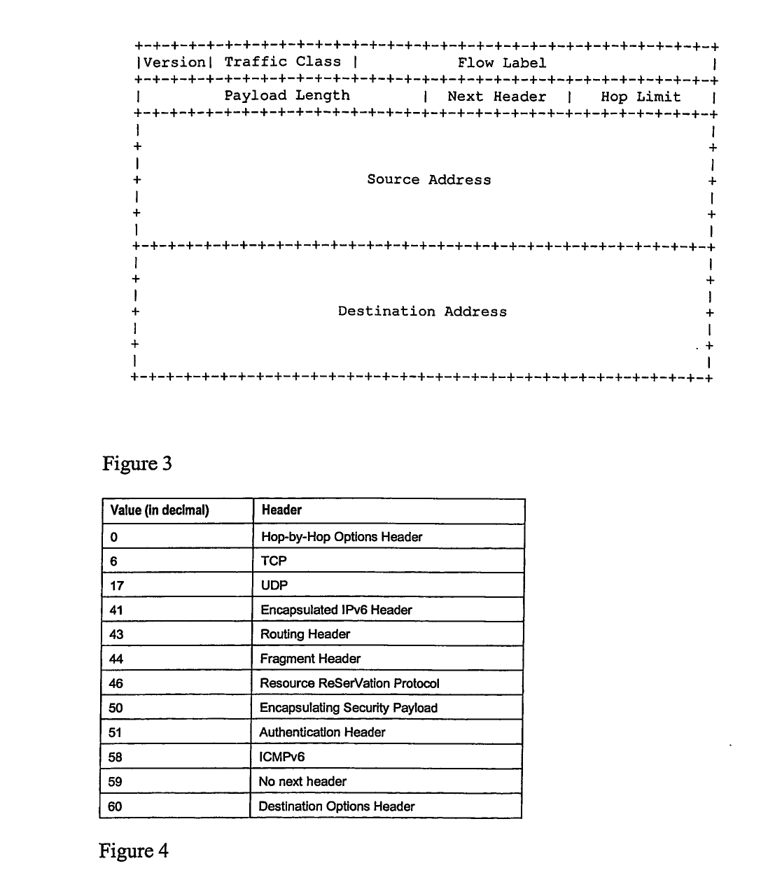

FIG. 3 shows the structure of the IPv6 header as defined in RFC 2460.

FIG. 4 shows the labels used for next header field of IPv6 header.

The process of handing over the MN from WLAN to UMTS occurs in a number of distinct steps whose timing is shown in FIG. 2. Each step is now described in detail.

Step 1—data packets are initially being transferred between CN and MN through the WLAN network

Step 2—a trigger is received or generated by the MN in response to events such as deteriorating WLAN channel quality or lower call tariff on alternative available network for example that necessitates a handover from current to new alternative network.

Step 3—in response to the trigger, the MN sends a SIP re-invite message to the CN through the new UMTS network. As the MN already knows the IP address of the CN, all SIP messages between MN and CN can go directly but the protocol does allow such messages to be routed via the UMTS SIP Register and proxy Server. The Re-invite message allows the MN and CN to re-negotiate details of the ongoing SIP session. The most relevant parameter to the current invention is the IP address of the MN's UMTS interface that is to be used by the CN to direct data packets after handover completion.

Step 4—the CN transmits a SIP 200-OK message to the MN agreeing to the change of IP

Step 5—for call reliability purposes, the MN transmits a SIP ACK message to the CN to conclude the SIP re-negotiation process. The arrival of the ACK at the CN is the trigger for CN to start using the new UMTS network related IP address to reach the MN.

Step 6—Just prior to using the new UMTS network related IP address for MN, the CN marks the last or last few packets transmitted on the WLAN media path. This is also triggered by the arrival of the ACK.

The SIP protocol is typically used to initiate real time Internet telephony or multimedia applications that use the unreliable UDP transport protocol. One possible but by no means optimised scheme to mark IP packets without incurring any overhead is to put the flag in the IP header. FIG. 3 shows the structure of the IPv6 header as defined in RFC 2460. The Next Header field indicates either the first extension header (if present) or the protocol in the upper layer PDU (such as TCP, UDP, or ICMPv6). FIG. 4 shows the possible values that this field can take. A decimal value of 17 indicates that there follows no next header, just a UDP payload. Similarly, a value of, say 18, could be used to indicate a special form of marked UDP payload. Alternative non-zero overhead packet marking schemes could be devised by embedding the marking within the payload of the packet that would have the additional advantage of not being UDP specific.

Step 7—data packets begin to be transferred between CN and MN through the new UMTS media path (the dotted line in FIG. 1). For some intervening period, MN will continue to receive packets transmitted on WLAN media path (including marked packets) until all the WLAN packets transmitted before the switch have been delivered.

The foregoing assumes that the MN already has UMTS and WLAN connectivity. If the MN does not already have UMTS connectivity, it will need to acquire a UMTS IP address between steps 2 and 3.

It will be appreciated that the steps can be applied similarly to handover from the UMTS network to a WLAN. Here it is more likely that the MN will not already have connectivity to the WLAN and a new IP address will need to be acquired.

In “sleep mode” the interface will usually be placed in a state in which it consumes less power but can be readily reactivated. Usually in sleep mode an IP address would not be relinquished, for example.

It is expected that after some pre-determined period of inactivity on its WLAN interface after the last of the WLAN packets have been received, the MN would send its WLAN interface into sleep mode to conserve power. The invention cuts down the time to go into sleep mode by using the arrival of marked packets as the trigger to initiate sleep mode.

1. A method of operating a mobile communications node which has at least two different interfaces for providing connectivity with first and second different communications networks respectively, and which is receiving data from a remote corresponding node via the first network, in which:
in response to a trigger, a SIP protocol related handover request is generated by the mobile node to initiate handover from the first network to the second network;
on completion of handover the first network interface is set to sleep mode; and
the initiation of sleep mode is synchronised with the cessation of the receipt of data packets via the first network.

2. A method as claimed in claim 1 in which the trigger is a signal sent to the mobile node.

3. A method as claimed in claim 1 in which the trigger is a signal generated by the mobile node.

4. A method as claimed in claim 1, 2 or 3 in which the handover request is sent from the mobile node to the corresponding node via the second network and the initiation of sleep mode is synchronised with the mobile node receiving an acknowledgement message from the corresponding node.

5. A method as claimed in claim 1, 2 or 3 in which the handover request is sent from the mobile node to the corresponding node via the second network, an acknowledgement message is sent from the mobile node to the corresponding node in response to an acknowledgement message returned from the corresponding node, and the initiation of sleep mode for the first network interface is synchronised with the sending of the acknowledgement message by the mobile node.

6. A method as claimed in claim 1, 2 or 3 in which the sleep mode for the first network terminal is initiated in response to a marker in the received data stream indicating that the stream via the first network has come to an end.

7. A method as claimed in any preceding claim in which one of the first and second networks is a UMTS network and the other is a wireless local area network.

8. A method of routing data packets in a mobile communications system including a mobile communications node as claimed in any preceding claim sending or receiving data packets to/from a corresponding node, in which just prior to re routing packets to the mobile node, the corresponding node is caused to mark the data stream to indicate to the mobile node that the data stream via the first network has come to an end.

9. A method as claimed in claim 8 in which the corresponding node marks the last or last few packets transmitted over the first network.

10. A method as claimed in claim 9 in which the mark for each packet is embedded in the packet header field.

11. A method as claimed in claim 8, 9 or 10 in which the handover request is sent from the mobile node to the corresponding node via the second network, an acknowledgement message is sent from the mobile node to the corresponding node in response to a message returned from the corresponding node and the corresponding node commences sending packets to the mobile node via the second network in response to the acknowledgement message.

12. A computer program product for installation in a mobile communications node, which mobile node has at least two different interfaces for providing connectivity with first and second different communications networks respectively whereby when the mobile node is receiving data from a remote corresponding node the data stream can be handed over from one network to the other, the program when installed enabling the mobile node to set to sleep mode the interface for the first network following handover to the second network in synchronisation with the cessation of the receipt of data packets via the first network.

13. A computer program product as claimed in claim 12 which enables the mobile node to initiate sleep mode for the first network interface in response to a marker in the received data stream indicating that the stream via the first network has come to an end.

14. A computer program product as claimed in claim 12 which enables the mobile node to synchronise initiation of sleep mode for the first network interface with the sending of a handover acknowledgement message from the mobile node to the corresponding node.
